(19) United States
(12) Patent Application Publication
(10) Pub. No.: US 2016/0014600 A1
(43) Pub. Date: Jan. 14, 2016

(54) Identification of Potential Improper Transaction

(71) Applicant: Bank of America Corporation, Charlotte, NC (US)

(72) Inventors: Carrie Anne Hanson, Charlotte, NC (US); Don Cardinal, San Antonio, TX (US); Pete Bertanzetti, Charlotte, NC (US)

(21) Appl. No.: 14/327,934

(22) Filed: Jul. 10, 2014

(51) Int. Cl. H04W 12/06; H04W 4/04; G06F 21/31; G06Q 30/02

(52) U.S. Cl. CPC H04W 12/06; G06Q 30/0282; H04W 4/04; G06F 21/31

(57) ABSTRACT

Systems and methods for using proximity positioning systems to determine multiple locations a user, identify the user and provide additional services and/or functionality based on the determined locations are presented. In some examples, a low-power radio signal emitted from a locating beacon may be detected by a personal computing device. The location of the beacon, and the device detecting the signal, may be determined. A low-power radio signal emitted from a second beacon may be detected and the location of the second beacon, and personal computing device detecting the signal, may be determined. If the signal from the first beacon was detected within a predetermined time threshold of detecting the second beacon, a flag may be triggered. Notifications may be transmitted to the user and/or the entity associated with the locating beacons to indicate the user may be in need of assistance and/or to reduce the risk of unauthorized activity.

### BACKGROUND

Companies that have a service component are often looking for ways to improve the experience that customers have when interacting with the company or its representatives, associates, and the like. Given the hectic schedules of people these days, it is important to provide efficient and effective customer service or assistance. Companies are also diligent about identifying potential suspicious activity and taking action to ensure that unauthorized or improper activity or transactions do not occur. Accordingly, additional information that can be used to enhance a customer service experience, as well as reduce or prevent unauthorized activity, may be advantageous.

### SUMMARY

Aspects of the disclosure relate to various systems, methods, apparatuses, and computer-readable media configured to use proximity positioning systems to determine one or more locations of a user, identify the user and provide additional services and/or functionality based on the determined location and/or identity. In some examples, a signal may be received or detected. The signal may be a low-power radio signal detectable within a predefined proximity and emitted from a locating beacon. The signal may, in some examples, be detected by a personal computing device of a user. The location of the beacon, and the device detecting the signal, may be determined (e.g., based on previously stored location information associated with the beacon). The location information, as well as a unique identifier associated with the personal computing device of the user, may be used to identify a user associated with the personal computing device and the location of the user. This information may be used to provide additional services and/or functionality to the user.

For instance, in some arrangements, the determined locations of the user may be compared to determine whether the detection of multiple locating beacons occurred within a predetermined period of time. If so, that may indicate a potential issue (e.g., customer service issue, suspicious activity, or the like). Accordingly, one or more notifications may be generated and transmitted to an entity associated with the system (e.g., a financial institution) and/or a user associated with the personal computing device, in order to address any potential issues.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more aspects discussed herein;

FIG. 2 depicts an illustrative block diagram of workstations and servers that may be used to implement the processes and functions of certain aspects of the present disclosure in accordance with one or more aspects discussed herein;

FIG. 3 depicts an illustrative computing environment for a proximity positioning system that may be used to provide location determination and user identification in accordance with one or more aspects discussed herein;

FIG. 4 illustrates one example location determination and user identification system according to one or more aspects discussed herein;

FIGS. 5A-5D depict an illustrative event sequence for identifying locations of a personal computing device of a user and determining whether action should be taken based on the identified locations and time between the device being positioned at a first location and a second location according to one or more aspects discussed herein;

FIG. 6 illustrates one example method of determining whether a personal computing device detected multiple locating beacons within a predetermined threshold period of time according to one or more aspects discussed herein;

FIG. 7 illustrates an example method of identifying one or more potential issues based on detection of signals within the predetermined threshold period of time according to one or more aspects described herein;

FIG. 8 illustrates one example user interface for providing a notification to a user that a personal computing device associated with the user has been detected at multiple locations according to one or more aspects described herein;

FIG. 9 illustrates one example notification that may be transmitted to a financial institution or other entity associated with the location beacons detected by the personal computing device in accordance with one or more aspects described herein; and

FIG. 10 illustrates another example user interface that may be transmitted to a financial institution or other entity associated with the location beacons detected by the personal computing device in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

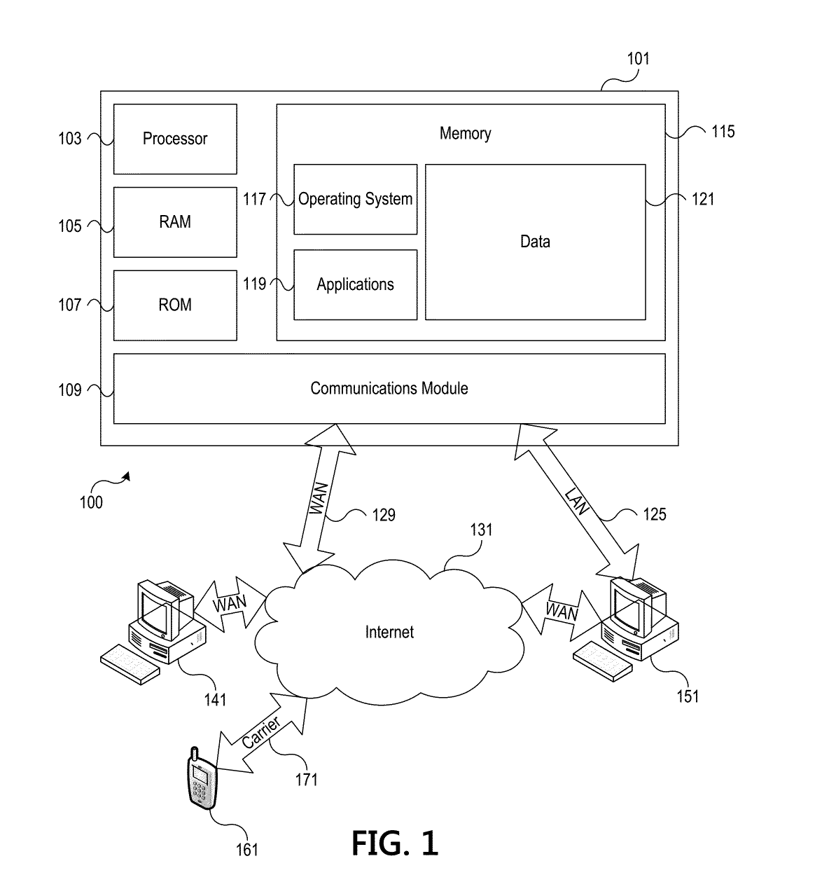

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

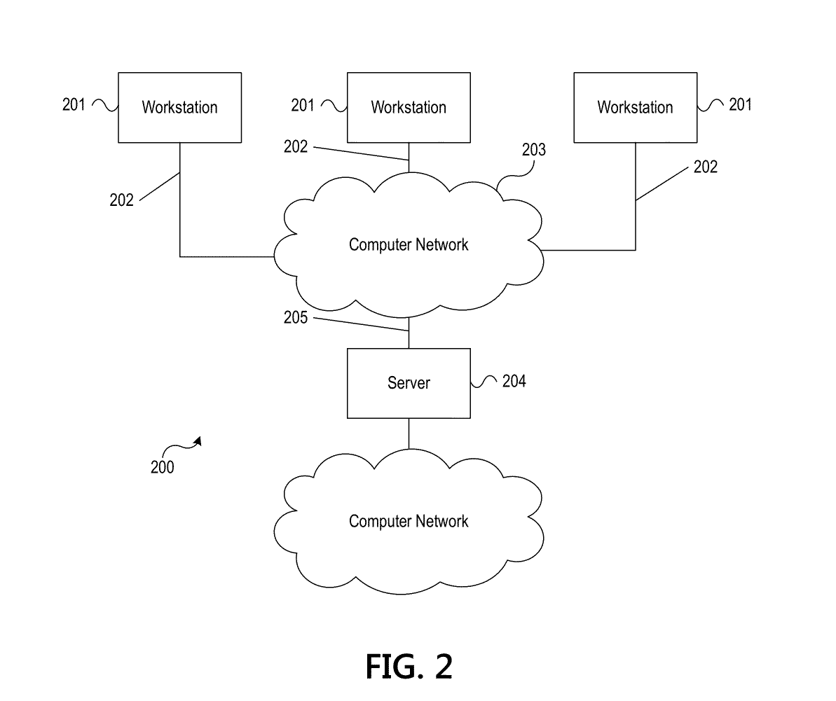

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode

(ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

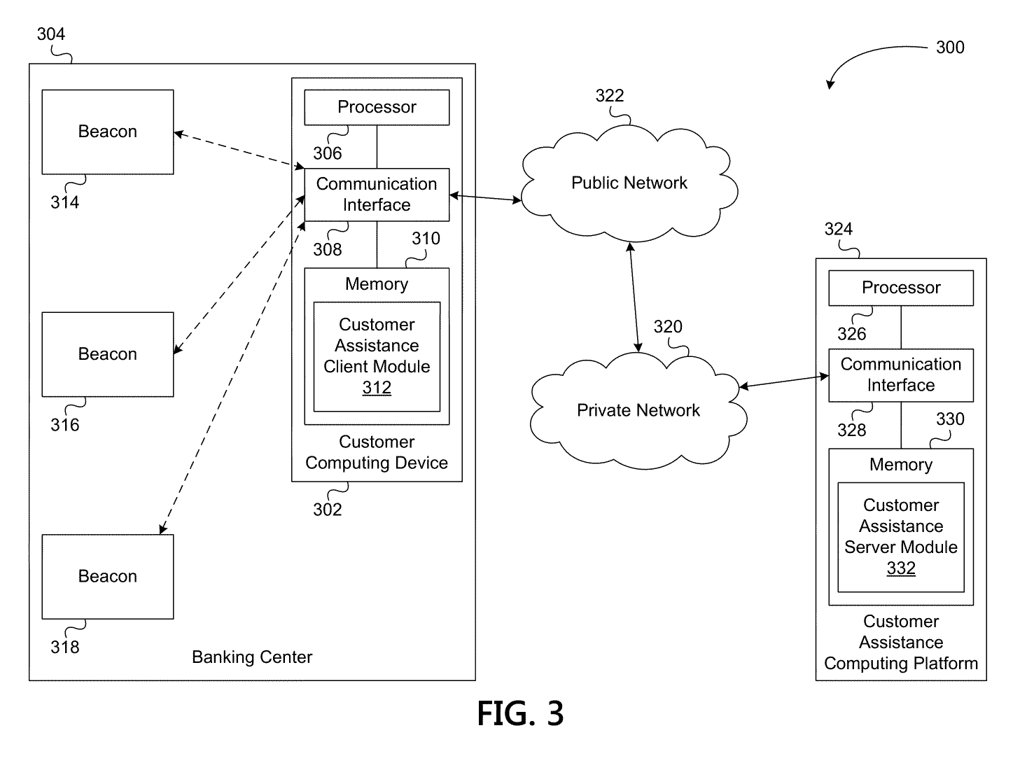

FIG. 3 depicts an illustrative computing environment for a location determination and user identification system in accordance with one or more example embodiments. Referring to FIG. 3, computing environment 300 may include one or more computing devices, such as customer computing device 302. Customer computing device 302 may be any type of computing device capable of receiving a user interface, receiving input via the user interface, and communicating the received input to one or more other computing devices. For example, customer computing device 302 may be a desktop computer, laptop computer, tablet computer, smart phone, or the like. In one or more arrangements, customer computing device 302 may be a personal computing device (e.g., a smart phone, a tablet computer, or any other type of mobile device) that belongs to and/or is used by a customer of a financial institution at and/or near a banking center 304 and/or any other location operated by, controlled by, and/or otherwise associated with the financial institution.

Computing environment 300 also may include one or more location beacons, such as location beacon 314, location beacon 316, and location beacon 318. Each location beacon (e.g., location beacon 314, location beacon 316, and location beacon 318) may be configured to transmit one or more radio signals that may be detected and/or received by other devices located in close proximity of and/or otherwise within a predetermined distance of the particular location beacon. In one or more embodiments, any and/or all of the location beacons included in computing environment 300 (e.g., location beacon 314, location beacon 316, and location beacon 318) may implement Bluetooth Low Energy (also referred to as “Bluetooth LE,” “Bluetooth Smart,” or “BLE”) technology to transmit low-power radio signals. The particular signal(s) transmitted by a particular location beacon may include one or more attributes, such as a unique identifier assigned to and/or otherwise associated with the particular location beacon, that may enable the particular location beacon to be identified by a device receiving the particular signal(s) transmitted by the particular location beacon. As illustrated below, by detecting a particular signal transmitted by a location beacon (which may, e.g., be positioned at a specific location) and subsequently identifying the location beacon transmitting the particular signal, a computing device may be able to determine that it is located at and/or near the specific location where the location beacon is positioned.

For example, in one or more arrangements discussed below, the one or more location beacons (e.g., location beacon 314, location beacon 316, and location beacon 318) may be positioned at and/or near banking center 304, and may be specifically positioned at and/or near different areas of banking center 304, such as at a welcome area, at a teller counter or window, at a waiting area, at an external alcove where an automated teller machine (ATM) is located, at an external window where drive-up services are provided, at a parking lot, and/or in one or more other distinct areas of banking center 304. In addition, each location beacon may transmit a radio signal that may be detected and/or received by other devices at banking center 304, such as customer computing device 302, which may enable such devices to determine that they are present at banking center 304 and/or located at and/or near a particular area of banking center 304.

In one or more embodiments, customer computing device 302 may include at least one processor 306, communication interface 308, and/or memory 310. A data bus may interconnect processor 306, communication interface 308, and/or memory 310. Memory 310 may include one or more program modules comprising instructions that when executed by processor 306 cause customer computing device 302 to perform one or more functions described herein. For example, memory 310 may include customer assistance client module 312, which may include instructions that when executed by processor 306 cause customer computing device 302 to perform one or more functions described herein. Communication interface 308 may include one or more wired and/or wireless communication interfaces (e.g., network interfaces, radio interfaces, or the like) that are configured to support communication between customer computing device 302 and one or more other devices and/or networks. In one or more arrangements, communication interface 308 may include at least one network interface that facilitates communication between customer computing device 302 and one or more devices and/or networks that are located remotely from banking center 304, and communication interface 308 may further include at least one radio interface that facilitates communication between and/or enables customer computing device 302 to receive wireless radio signals from one or more location beacons (e.g., location beacon 314, location beacon 316, and location beacon 318) and/or other radio transmitters that may be located at and/or near banking center 304.

Computing environment 300 also may include one or more computing platforms. For example, computing environment 300 may include customer assistance computing platform 324. Customer assistance computing platform 324 may include one or more computing devices configured to perform one or more of the functions described herein. For example, customer assistance computing platform 324 may include one or more computers (e.g., laptop computers, desktop computers, servers, server blades, or the like).

Computing environment 300 also may include one or more networks, which may interconnect customer computing device 302, customer assistance computing platform 324, and/or one or more other computing devices. For example, computing environment 300 may include private network 320 and public network 322. Private network 320 and/or public network 322 may include one or more sub-networks (e.g., LANs, WANs, or the like). Private network 320 may be associated with a particular organization (e.g., a corporation, financial institution, educational institution, governmental institution, or the like) and may interconnect one or more computing devices associated with the organization. For example, customer assistance computing platform 324 may be associated with an organization, such as the financial institution that operates, controls, and/or is otherwise associated with banking center 304, and private network 320 may be operated by and/or otherwise associated with the organization, and may include one or more networks (e.g., LANs, WANs, VPNs, or the like) that interconnect customer assistance computing platform 324 and one or more other computing devices associated with the organization. Public network 322 may connect private network 320 and/or one or more computing devices connected thereto (e.g., customer assistance computing platform 324) with one or more networks and/or computing devices that are not associated with the organization. For example, customer computing device 302 might not be associated with the organization that operates and/or is associated with private network 320, and public network 322 may include one or more networks (e.g., the Internet) that connect customer computing device 302 to private network 320 and/or one or more computing devices connected thereto (e.g., customer assistance computing platform 324).

Customer assistance computing platform 324 may include at least one processor 326, communication interface 328, and/or memory 330. Memory 330 may include one or more program modules comprising instructions that when executed by processor 326 cause customer assistance computing platform 324 to perform one or more functions described herein. For example, memory 330 may include customer assistance server module 332, which may include instructions that when executed by processor 326 cause customer assistance computing platform 324 to perform one or more functions described herein. Communication interface 328 may include one or more wired and/or wireless communication interfaces (e.g., network interfaces, radio interfaces, or the like) that are configured to support communication between customer assistance computing platform 324 and one or more other devices and/or networks. For example, communication interface 328 may include at least one network interface that facilitates communication between customer assistance computing platform 324 and one or more other devices and/or networks (e.g., private network 320, public network 322, customer computing device 302, and/or other devices and networks).

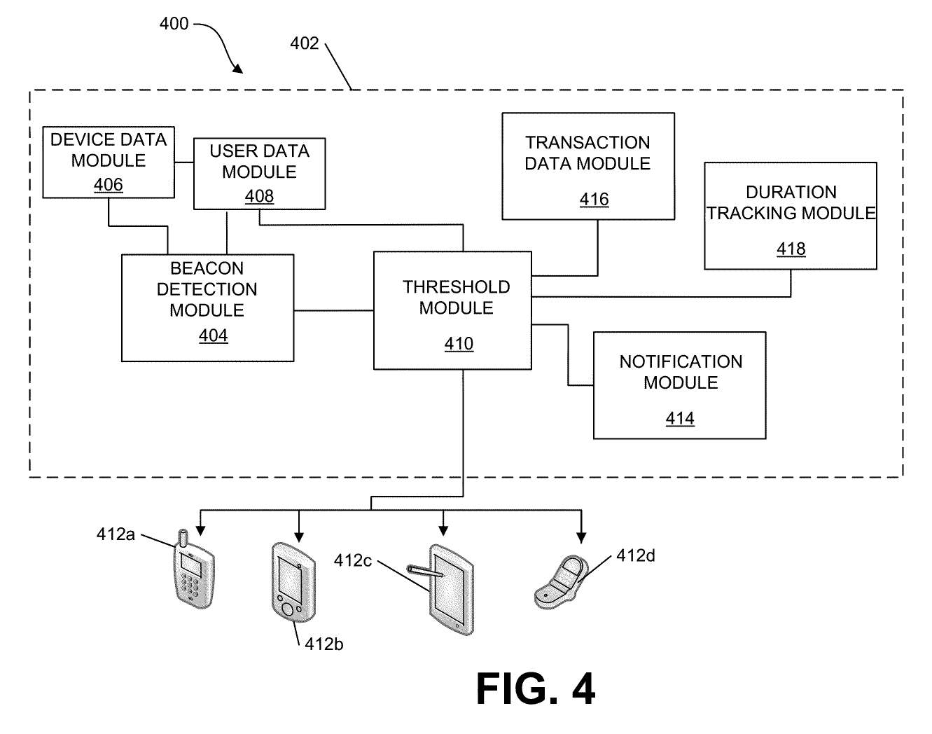

FIG. 4 illustrates one example location determination and user identification system 400 according to one or more aspects described herein. In some examples, the location determination and user identification system 400 may be part of, internal to or associated with an entity 402. The entity 402 may be a corporation, university, government entity, and the like. In some examples, the entity 402 may be a financial institution, such as a bank. Although various aspects of the disclosure may be described in the context of a financial institution, nothing in the disclosure shall be construed as limiting the location determination and user identification system to use within a financial institution. Rather, the system may be implemented by various other types of entities.

Further, some aspects of the location determination and user identification system 400 may be contained in one or more computing devices, servers, or the like. For instance, the location determination and user identification system 400 may include one or more modules that may be implemented in hardware and/or software configured to perform various functions within the system 400. One or more modules may be contained within the same physical device or may be housed in separate devices. Further, although one or more modules may be shown in FIG. 4 as within the entity 402, any of the modules may be located external to the entity 402 but may be associated with the entity. For instance, one or more modules may be associated with a personal computing device of a user. Accordingly, various functionality associated with the module may be performed at the personal computing device which may be located external to the entity but may be associated with the entity by way of a user associated with the device being associated with the entity 402, the device including or running an application, such as a mobile banking application, of the entity 402, and the like. Nothing in the disclosure should be viewed as limiting the one or more modules to a same physical location or a location within an entity.

Location determination and user identification system 400 may include a beacon detection module 404. The beacon detection module 404 may be implemented in hardware and/or software and may be configured to perform various functions within the system 400. For instance, the beacon detection module 404 may be configured to detect and/or receive a signal associated with one or more beacons, such as location beacons 314, 316, 318 in FIG. 3. The location beacons may be arranged within or in proximity to a location (e.g., a branch or banking center) and may be part of a proximity positioning system that may be used to identify a location of a computing device and, accordingly, a user associated with the computing device, as will be discussed more fully below.

The beacon detection module 404 may receive a signal emitted from one or more location beacons and may determine a location of the beacon and/or a personal computing device associated with a user that is within a predefined proximity of one or more locating beacons. For instance, if a personal computing device, such as one of devices 412a-412d is in a location that is within a predefined proximity of one or more location beacons emitting a signal, the personal computing device 412a-412d (e.g., via the beacon detection module 404) may detect the signal and determine, such as from the received signal, a location of the beacon and/or a location of the device. In some examples, an application on the personal computing device 412a-412d may be used to detect the signal from the beacon and/or determine a location of the beacon and/or personal computing device 412a-412d.

The signal received from the beacon and/or data associated with the signal (such as location data) may be transmitted to a device data module 406. The device data module 406 may be implemented in hardware and/or software configured to perform various functions within the system. For instance, the device data module 406 may receive the signal from the beacon or data associated therewith from the beacon detection module 404 and may determine a unique identifier associated with the personal computing device 412a-412d associated with the beacon detection module 404 that detected the beacon. That is, the device data module 406 may determine a unique identifier, such as a phone number associated with a smart phone 412a, an international mobile station equipment identity (IMEI), or other unique identifier associated with the personal computing device within the predefined proximity of the beacon.

The signal from the beacon detection module 404 and/or the device identifier from the device data module 406 may be transmitted to a user data module 404. In some examples, the user data module 408 may be located remotely from the beacon detection module 404 and/or the device data module 406. For instance, the user data module 408 may be located in, for example, a back office of a financial institution. The user data module 408 may be implemented in hardware and/or software configured to perform various functions within the system 400. For instance, the user data module 408 may receive data from the beacon detection module 404 associated with a location of the beacon and/or a location of the personal computing device detecting the beacon signal. The user data module 408 may also receive the unique identifier retrieved from the device data module 406 to determine a user associated with the device and, therefore, a location of the user associated with the device based on the location of the device.

In some arrangements, a user may register with the system 400. Registration with the system 400 may include registering a unique identifier associated with one or more personal computing devices of the user. Registration with the system 400 may also include providing identifying information associated with the user. For instance, a name, address, phone number, online or mobile banking user identification, and the like, may be provided in registering with the system. In some examples, the system 400 may obtain registration information directly from the user (e.g., via an online or other direct registration process). Additionally or alternatively, the system 400 may obtain some or all of the registration information from information a user provided to an online banking application, mobile banking application, or the like.

In some arrangements, the registration information may be stored in the user data module 408. Accordingly, upon receiving information associated with a beacon signal and/or a unique identifier associated with a personal computing device, the user data module 408 may determine or identify a user associated with the personal computing device. Thus, the fact that the device associated with the user has detected a beacon signal indicates that the device is within a predefined proximity of the beacon and, thus, the user is also (at least likely) within the same proximity of the beacon. If the beacon is located within a particular location, such as a branch of a financial institution, this information may be used to determine when a user is within the branch and provide additional services, functionality, etc. to the user based on the identification of the user and determination of the location of the user based on the determined location of the personal computing device associated with the user.

One example of an additional service or functionality that may be provided based on the determined identification and location of the user may be detecting multiple visits to either a same location or multiple locations of a similar type within a predetermined amount of time. For example, if a personal computing device is identified as being in the same bank branch or banking center multiple times within one day, one week, or the like, that may indicate that an issue is occurring with that user (e.g., the user is not getting the appropriate assistance needed, the user is not being properly informed of what is needed to conduct a transaction, or the like). In another example, detection of a user at multiple different branches or banking centers within a predetermined time period (e.g., two hours, one business day, one week, or the like) may indicate that the user has an issue that is not being properly resolved and, thus, the user is attempting to obtain better service at different branches. In yet another example, detection of a user device a multiple different branches or banking centers within a predetermined time period may indicate that some form of unauthorized activity may be underway. Accordingly, the system may flag any of these occurrences and notify the user, the financial institution or other entity implementing the system, or both, in order to assist the user or confirm whether the user is, in fact, in possession of the personal computing device (e.g., to thwart potential unauthorized activity if, for instance, a user's personal computing device has been stolen). These and various other examples will be discussed more fully below.

The location determination and user identification system 400 may include a threshold module 410. The threshold module 410 may be implemented in hardware and/or software configured to perform various functions within the system. For instance, the threshold module may receive data associated with an indication of a personal computing device 412a-412d at multiple different locations of a similar type and may determine whether the personal computing device 412a-412d was at the multiple different locations within a predetermined threshold period of time.

In some arrangements, the personal computing device 412a-412d may detect a location beacon (such as beacon 314) via the beacon detection module 404. As discussed above, the personal computing device may be identified and the location of the beacon, and thus, the personal computing device, may be determined. A user associated with the personal computing device 412a-412d may also be determined. This data may be transmitted to the threshold module 410. The data may further include a date and/or time at which the personal computing device 412a-412d detected the location beacon signal and, thus, was in the determined location. This information may be compared with other location information received by the threshold module 410. For instance, data associated with the personal computing device 412a-412d detecting another location beacon (such as beacon 316 or 318) at a different location.

The threshold module 410 may identify the locations as similar types of locations (e.g., each of location beacons 314, 316, or 318 is arranged at a different branch or banking center of a financial institution) based on the location data received. Further, the threshold module 410 may compare date and/or time data received to determine whether the personal computing device 412a-412d was at the location of the multiple different location beacons within a predetermined threshold period of time. For instance, the threshold module 410 may determine whether the personal computing device 412a-412d detected the signal from the different beacons (and, thus, was in proximity to the determined location of the respective beacons) within one hour, two hours, five hours, one business day, twenty four hours, one week, one month, or the like. Any predetermined threshold may be used to compare the location information.

Based on the comparison performed, the threshold module 410 may flag any instances in which the personal computing device 412a-412d detected more than one beacon within the predetermined threshold amount of time. Flagging the instances may include flagging the personal computing device 412a-412d, flagging the identified user associated with the personal computing device 412a-412d, and/or providing a notification of the flag to the user, the financial institution or other entity at which the beacons are arranged, or both.

For instance, if one or more instances are flagged by the threshold module 410, the instances may be transferred to the notification module 414. The notification module 414 may be implemented in hardware and/or software configured to perform various functions within the system 400. For instance, the notification module 414 may generate a notification to a user and/or a financial institution or entity at which the locating beacons are arranged. In one example, a notification may be generated for a user. The notification may include identification of the instances that were flagged (e.g., the locations at which the personal computing device 412a-412d was determined to be located, the dates and/or times of the location of the personal computing device 412a-412d within proximity of the beacons, and the like). In some examples, the notification may include a request that the user confirm that he or she was, in fact, at the identified locations (e.g., had a physical presence at the locations), in order to ensure that the personal computing device 412a-412d of the user was not stolen and/or being used in association with any unauthorized activity.

In some examples, the notification may include a plurality of recent transactions associated with the user. For instance, the notification module 414 may retrieve, such as from transaction data module 416, a listing of a plurality of recent transactions associated with the user (e.g., transactions conducted using a debit card associated with the user, a credit card associated with the user, deposits or withdrawals to/from a bank account of the user, and the like). This information may be included in the notification provided to the user to provide the user an opportunity to verify that the recent transactions were authorized transactions made by the user or a person operating on behalf of the user.

The notification may, in some examples, be transmitted to the personal computing device 412a-412d of the user. Accordingly, the user may provide any requested input in response to the notification via the personal computing device 412a-412d.

Additionally or alternatively, notification module 414 may generate one or more notifications to be transmitted to the financial institution or other entity at which the beacons are located. For instance, a notification identifying the instances of detection, dates and/or times, and the like, may be provided to the financial institution. This information may be provided to one or more associates within the financial institution. For instance, the information may be provided to a bank teller, financial advisor, or the like. In some examples, the notification may be transmitted to the financial institution upon flagging the instances and/or may be transmitted to, for instance, a bank teller upon receiving notification of the personal computing device 412a-412d detecting a signal associated with the beacon at which the bank teller is present. Accordingly, the bank teller may request additional identification, authorization, may inquire as to whether the user is receiving the desired service, and the like.

Further, the notification may be received by the financial institution and may provide the financial institution with an indication that, perhaps, the user is not receiving the desired level of customer service. Accordingly, a representative of the financial institution may contact the user to offer additional assistance.

The location determination and user identification system 400 may further include a duration tracking module 418. In some examples, the duration of the visit to the location of the beacon (e.g., a difference between a date/time when the locating beacon signal was detected by the personal computing device 412a-412d and when the signal ceased being detected by the personal computing device 412a-412d) may be determined. This information may be used to evaluate whether the user (or person in possession of the personal computing device 412a-412d) was conducting a transaction or other business at the location or was merely there briefly to evaluate the location (e.g., in preparation for conducting one or more unauthorized activities).

These and other arrangements will be discussed more fully below.

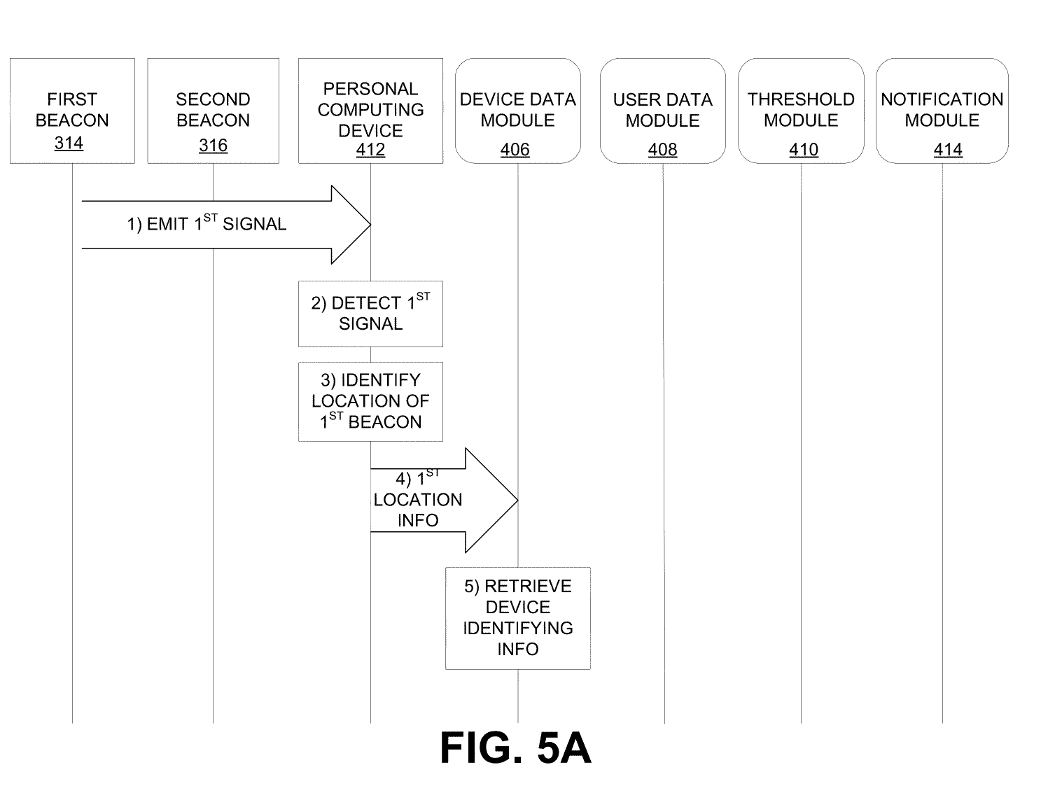

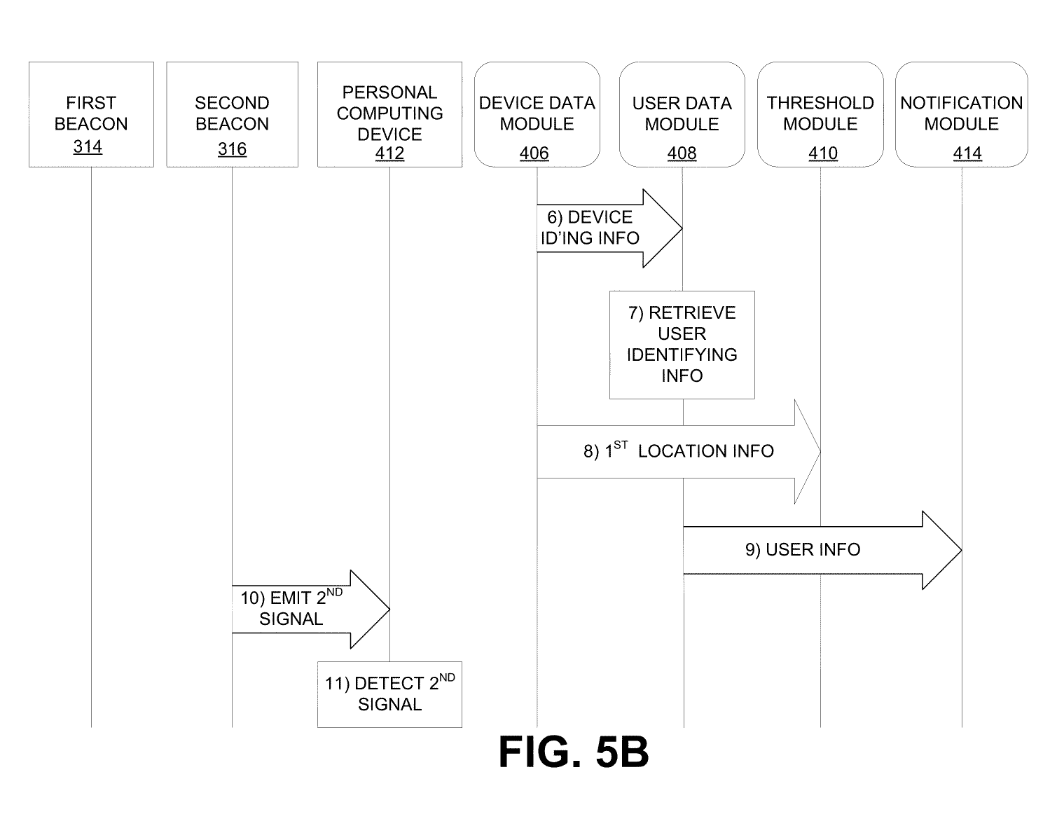

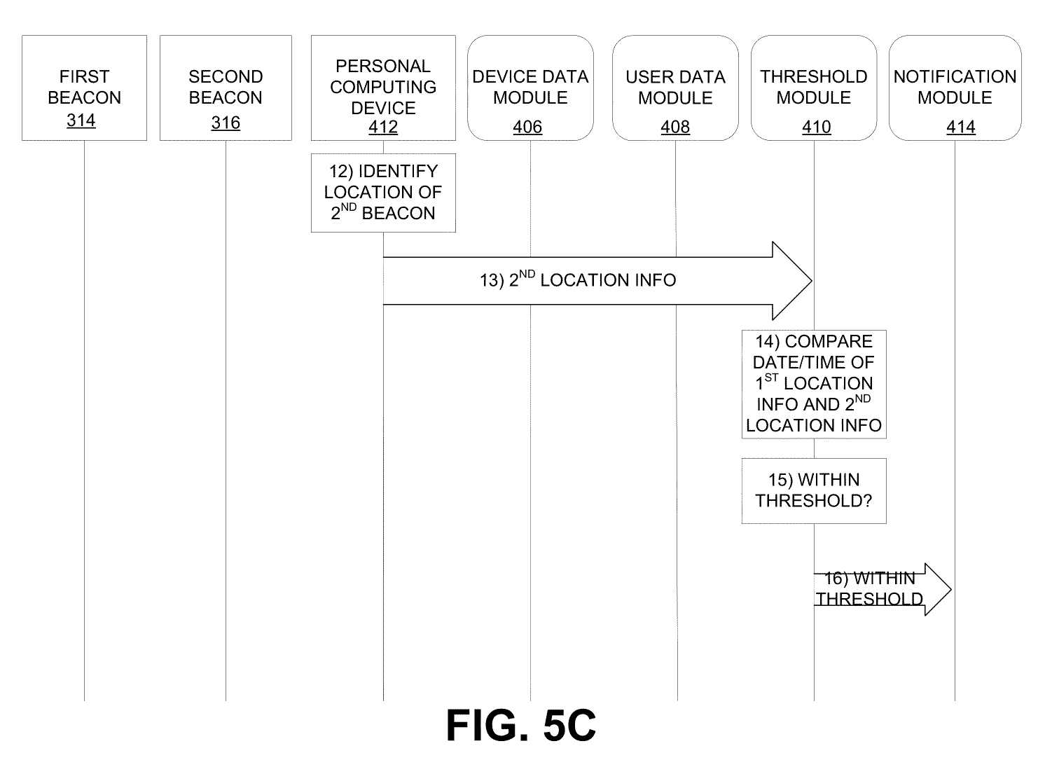

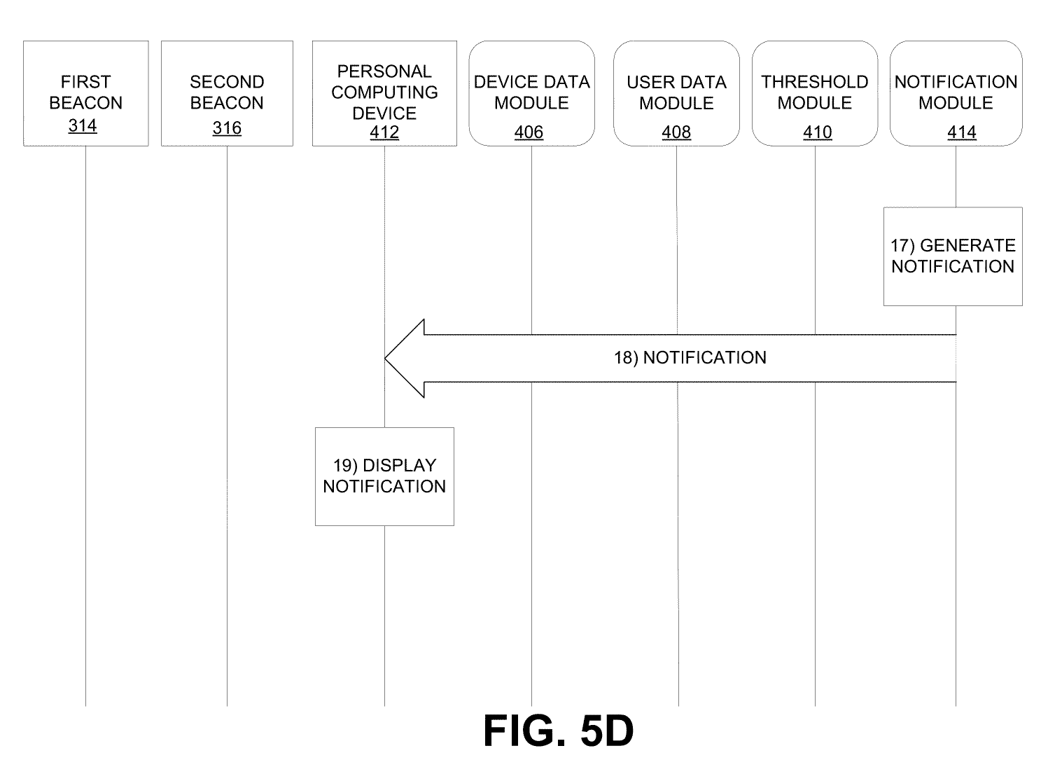

FIGS. 5A-5D depict an illustrative event sequence for utilizing a location determination and user identification system in accordance with one or more aspects discussed herein. The example shown in FIGS. 5A-5D is merely one example sequence and various other steps, processes, or the like, may be included in a sequence without departing from the invention.

Referring to FIG. 5A, at step 1 a signal may be emitted from a first beacon, such as location beacon 314 in FIG. 3. The signal may include data identifying the first beacon and/or a first location of the first beacon. In some examples, the first beacon may be located in a first branch or banking center of a financial institution.

At step 2, the signal emitted by the first beacon may be detected, such as by a personal computing device. As discussed above, the signal emitted by the first beacon may be a low-power radio signal such that detection of the signal might be possible when the personal computing device is within a predefined proximity of the first beacon. Accordingly, the personal computing device must be near to the first beacon in order to detect the signal.

Based on the received signal, a location of the first beacon, and, thus, an approximate location of the personal computing device, may be determined in step 3. For instance, in some examples, the personal computing device may include an application configured to communicate with the first beacon and/or receive and/or provide information associated with the first beacon, location, and the like, to a system associated with an entity, such as a financial institution. Example applications may include online banking applications and/or mobile banking applications. Accordingly, the application may detect the signal associated with the first beacon and determine a location of the first beacon (and thus an approximate location of the personal computing device). Determining the location of the first beacon may be based on records stored on the personal computing device, or accessible via the online banking application or mobile banking application, identifying locations of beacons. For instance, the location of beacons in each branch of the financial institution may be accessible via the online banking application or mobile banking application.

Although the example above includes identifying the location of the first beacon and/or the personal computing device by the personal computing device (or application associated therewith), in some arrangements, the signal or data associated with the signal, may be transmitted from the personal computing device to another computing device or server in order to identify the location. For instance, the signal or data associated therewith may be transmitted to a server at a back office of a financial institution, such as customer assistance computing platform 324 in FIG. 3. The location of the first beacon, and approximate location of the personal computing device, may then be determined at the remote server or platform using processes similar to those discussed above.

At step 4, the determined location of the first beacon (1^{st} location information) may be transmitted, for instance to a device data module 406, to retrieve device identifying information in step 5. As discussed above, device identifying information may include IMEI of the device, and the like.

Referring to FIG. 5B, the first location of the personal computing device, and identifying information retrieved associated with the personal computing device, may be transmitted, for instance, to the user data module 408 in step 6. The user data module 408 may receive the information and use, for instance at least the device identifying information, to identify a user associated with the personal computing device. Information associated with the identified user may be retrieved in step 7.

At step 8, the first location information (e.g., location of the first beacon) may be transmitted to a threshold module 410. In some examples, the first location information may include a time and/or date at which the personal computing device detected the first signal from the first beacon. At step 9, the information associated with the identified user may be transmitted to a notification module for use in providing a notification to the user (e.g., in step 18).

At step 10, a signal from a second beacon, such as locating beacon 316 in FIG. 3, may be emitted. Similar to the arrangement discussed above at step 1, the signal may include data identifying the beacon and/or a location of the second beacon. In some examples, the second beacon may be located in a second, different branch or banking center of a financial institution.

At step 11, the signal emitted by the second beacon may be detected, such as by the personal computing device 412. As discussed above, the signal emitted by the second beacon may be a low-power radio signal such that detection of the signal might be possible when the personal computing device is within a predefined proximity of the second beacon. Accordingly, the personal computing device must be near to the second beacon in order to detect the signal.

With reference to FIG. 5C, based on the received signal, a location of the second beacon, and, thus, an approximate location of the personal computing device, may be determined in step 12. Similar to the arrangements discussed above, the personal computing device may include an application configured to communicate with the second beacon and/or receive and/or provide information associated with the second beacon, second location, and the like, to a system associated with an entity, such as a financial institution. Example applications may include online banking applications and/or mobile banking applications. Accordingly, the application may detect the signal associated with the second beacon and determine a location of the second beacon (and thus an approximate location of the personal computing device). Determining the location of the second beacon may be based on records stored on the personal computing device, or accessible via the online banking application or mobile banking application, identifying locations of beacons. For instance, the location of beacons in each branch of the financial institution may be accessible via the online banking application or mobile banking application.

Although the example above includes identifying the location of the second beacon and/or the personal computing device by the personal computing device (or application associated therewith), in some arrangements, the signal or data associated with the signal, may be transmitted from the personal computing device to another computing device or server in order to identify the location. For instance, the signal or data associated therewith may be transmitted to a server at a back office of a financial institution, such as customer assistance computing platform 324 in FIG. 3. The location of the second beacon, and approximate location of the personal computing device, may then be determined at the remote server or platform using processes similar to those discussed above.

At step 13, the second location information (e.g., the determined location of the second beacon and, thus, the personal computing device at that particular time/date) may be transmitted to the threshold module. At step 14, the first location information and second location information may be compared to determine whether the locations are a similar type of location and whether the personal computing device detected the signal from the first beacon and the signal from the second beacon within a predetermined threshold period of time. The determination may be made in step 15 and, if the personal computing device detected the signal from the first beacon and the signal from the second beacon within the predetermined threshold period of time, in step 16 that information may be transmitted to a notification module to generate appropriate notifications.

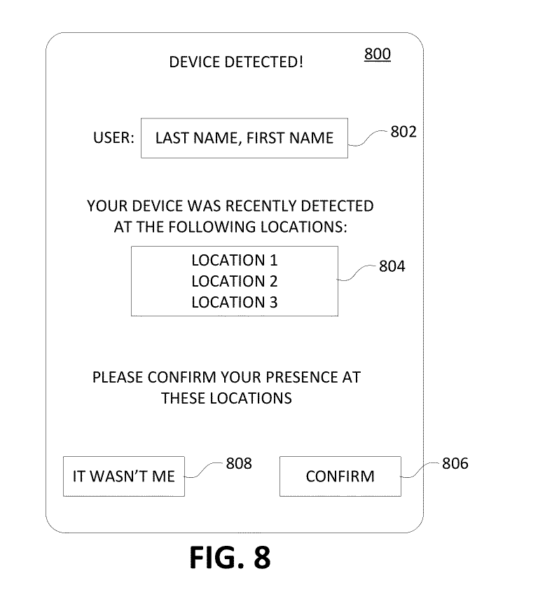

With reference to FIG. 5D, in step 17, one or more notifications may be generated. In step 18, a notification generated for a user may be transmitted to the personal computing device. In step 19, the notification may be displayed on the personal computing device. One example notification is illustrated in FIG. 8 and will be discussed more fully below.

Various additional steps may be provided in this or other event sequences without departing from the invention. For instance, steps associated with requesting additional authenticating information from a user, transmitting a notification to the financial institution, and the like, as discussed herein, may be provided in this or other event sequences without departing from the invention.

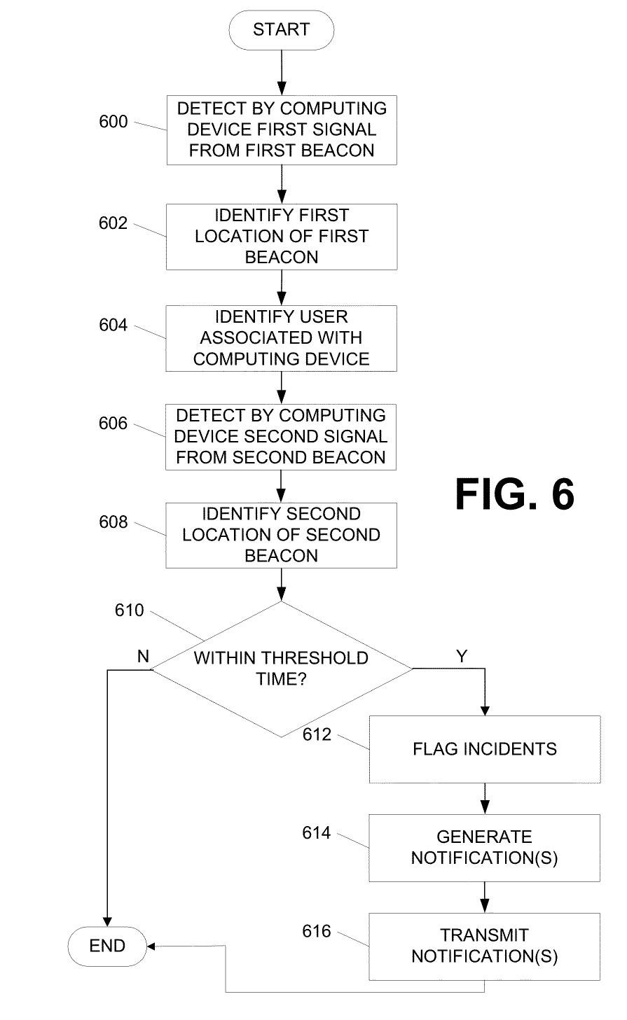

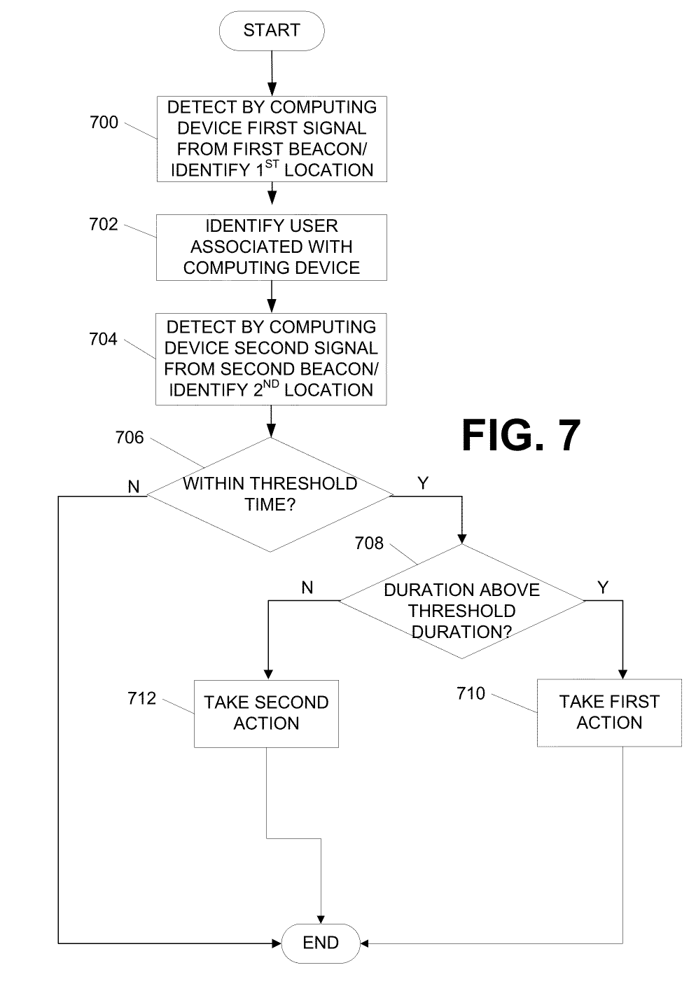

FIGS. 6 and 7 illustrate example methods of implementing the systems and arrangements discussed above. The steps described in FIGS. 6 and 7 may be performed in a different order than the order presented herein and nothing in the specification or figures should be viewed as limiting the order of the steps to the order described herein.

FIG. 6 illustrates one example method of determining whether a personal computing device detected multiple locating beacons within a predetermined threshold period of time according to one or more aspects discussed herein. In step 600, a first signal from a first location beacon may be detected by a personal computing device. As discussed above, the first signal may be a low-power radio signal that may only be detectable when the detecting device (e.g., the personal computing device) is within a predetermined proximity of the beacon, which may be a relatively small distance. In step 602, the first location of the first beacon and, thus, the personal computing device, may be determined. The location may be determined in various ways, as discussed above.

In step 604, a user associated with the personal computing device may be identified.

As discussed above, the user may be identified based on the unique identifier associated with the personal computing device, registration records or information, online or mobile banking information provided, or the like.

In step 606, a second signal from a second location beacon may be detected by the personal computing device. The second beacon may be different from the first beacon and may be in a different location than the first beacon. For instance, the first beacon may be arranged in a first branch or banking center of a financial institution and the second beacon may be arranged in a second, different branch or banking center of the financial institution. In step 608, the location of the second beacon may be determined.

In step 610, a determination may be made as to whether the personal computing device detected the first signal, or received data associated with the first signal, from the first beacon within a threshold period of time of detecting the second signal, or receiving data associated with the second signal, from the second beacon. For instance, if both signals were detected within the predetermined threshold period of time (e.g., one hour, one business day, one week, or the like) that may indicate that the user is in need of assistance, or that a potential unauthorized activity is taking place.

If, in step 610, the signals were not detected within the threshold period of time (e.g., the signals were detected over a greater time period) the process may end. Alternatively, if, in step 610, a determination is made that the signals were detected within the threshold period of time, then, in step 612, the incidents of detection may be flagged. Flagging the incidents may prompt generation of one or more notifications in step 614. For instance, a notification to a user indicating that a personal computing device associated with him or her was detected at multiple locations within the predetermined threshold time period may be generated. Additionally or alternatively, a notification to the financial institution may be generated indicating that the personal computing device detected signals at multiple locations within the predetermined threshold period of time. In step 616, the one or more notifications may be transmitted (e.g., to the user, financial institution, or the like).

FIG. 7 illustrates another example method of identifying one or more potential issues based on detection of signals within the predetermined threshold period of time according to one or more aspects described herein. In step 700, a personal computing device may detect a first signal from a first location beacon and the first location of the first location beacon may be determined. In step 702, a user associated with the personal computing device may be identified.

In step 704, the personal computing device may detect a second signal from a second beacon in a second location. The second location may also be determined. In step 706, similar to step 610, a determination may be made as to whether the first signal and second signal were detected within a predetermined threshold period of time. If not, the process may end. If so, a determination may be made, in step 708, as to whether the duration of the signal detection (e.g., a time elapsed between the initial detection of the first signal and the first signal ceasing to be detected by the personal computing device, and a time elapsed between the initial detection of the second signal and the second signal ceasing to be detected by the personal computing device) is above a predetermined threshold. The duration determination may include evaluating the duration of the signal detection at the first location, the detection of the second signal at the second location or both.

If, in step 708, the duration is above the predetermined threshold, a first action may be taken. For instance, if the duration of the detection of the first signal and the second signal are rather lengthy (e.g., above the threshold), that may indicate that the user is conducting transactions or other business or is attempting to obtain customer service but might not be receiving the service desired (e.g., one branch or banking center was not able to assist so the user tried another branch or banking center). Accordingly, this may indicate that the user is in need of additional customer service and the first action taken may include contacting the user (e.g., via telephone, text, email, a mobile or online banking application, a notification transmitted to the personal computing device, or the like) to inquire as to whether the user is in need of additional assistance. Various other actions may be taken in response to determining that the signal detections were above the duration threshold without departing from the invention.

If, in step 708, the duration is at or below the predetermined threshold, a second, different action may be taken. For instance, if the signal detection duration is relatively short (e.g., at or below the threshold), that may indicate that the user (or person in possession of the personal computing device) is not actually conducting transactions or receiving assistance. Rather, the user or person in possession of the personal computing device may be evaluating the location in preparation for attempting one or more unauthorized activities. Accordingly, the second action may include contacting the user to confirm whether the user is in possession of the personal computing device, alerting banking associates to a potential issue, and the like. Various other actions may be taken in response to determining that the signal detections were at or below the duration threshold without departing from the invention.

FIG. 8 illustrates one example user interface 800 providing a notification to a user that a personal computing device associated with the user has been detected at multiple locations according to one or more aspects described herein. The interface 800 includes field 802 in which the name of the user is provided. Field 804 identifies the plurality of locations at which the personal computing device of the user detected a location beacon signal. The user interface 800 further includes a request for the user to confirm that he or she was at the identified locations. If the user was at the identified locations, the user may select “CONFIRM” option 806. If the user was not at the identified locations, the user may select “IT WASN'T ME” option 808. Selection of option 808 may prompt display of one or more additional user interfaces. For instance, information may be provided to the user regarding next steps. Additionally or alternatively, a listing of recent transactions associated with the user or one or more accounts of the user may be presented to the user for review (e.g., to confirm whether any of the transaction were unauthorized transactions, or the like). The example notification in interface 800 may be provided to the user via the personal computing device of the user.

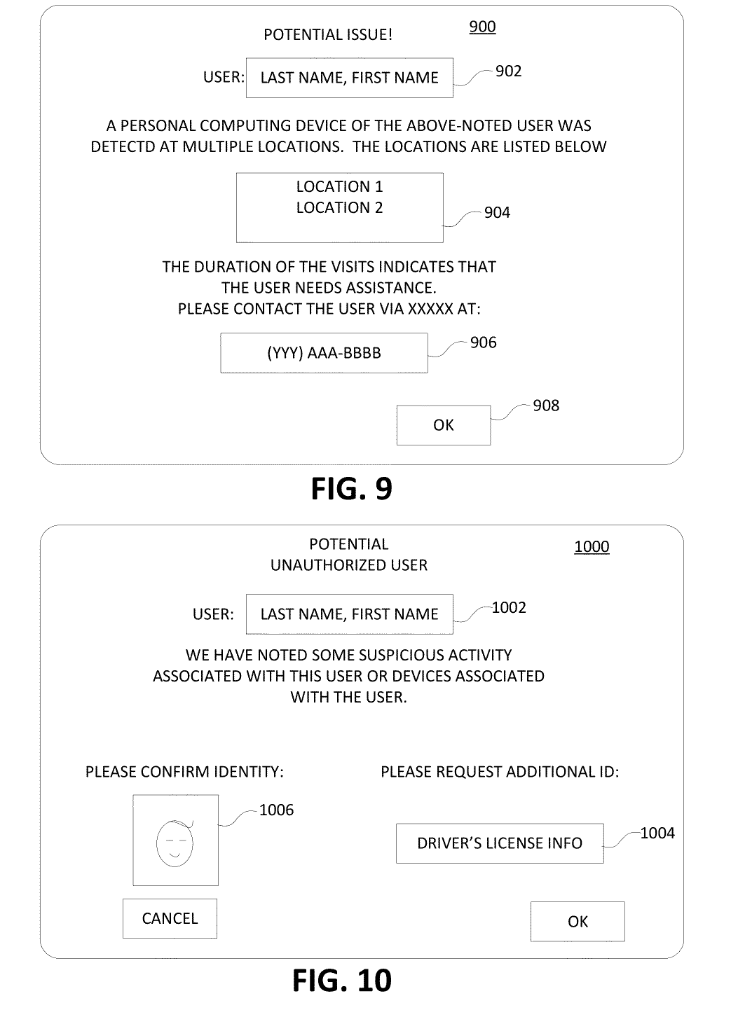

FIG. 9 illustrates one example notification that may be transmitted to a financial institution or other entity associated with the location beacons detected by the personal computing device. Interface 900 includes field 902 in which the name of the user is provided. Field 904 indicates the locations at which the personal computing device of the user detected a location beacon. The interface 900 further provides contact information for the user in field 906. Accordingly, a banking associate may contact the user to ensure that they received the service they desired and inquire as to whether they need any additional services.

FIG. 10 illustrates another example user interface that may be transmitted to a financial institution or other entity associated with the location beacons detected by the personal computing device. In some examples, the interface 1000 may be provided to, for instance, a bank teller or other banking associate, in order to alert the teller or banking associate of a potential for unauthorized activity based on the detection of the personal computing device at multiple locations within the predetermined threshold period of time. Interface 1000 includes field 1002 in which the name of the user is provided. The interface 1000 may indicate that there is a potential issue with this user and that additional identification information should be requested from the user. For instance, the interface 1000 includes field 1004 in which a driver's license number of the user may be provided. For example, if the user enters the banking center, a teller may request photo identification before completing any transactions. The teller may input the driver's license number into field 1004 to provide identifying information.

Further, the interface 1000 may include a photo of the user in field 1006. The photo may have been captured during a registration process, as discussed above or during another transaction. Accordingly, the teller or banking associate may be able to easily determine whether the user matches the image provided.

Below are various example arrangements in which the location determination and user identification system may be implemented. The arrangements discussed below are merely some example arrangements and should not be viewed as limiting the disclosure in any way. Various other arrangements may be implemented or used without departing from the invention.

As discussed above, the location determination and user identification system may implement proximity positioning systems, or features associated therewith, to identify a user and determine one or more locations of a user within a time period based on a determined location of a personal computing device associated with the user. Additional services and/or functionality may then be provided to the user and/or a financial institution or other entity implementing the system, based on this information.

For example, as discussed above, one or more locations of a user, based on the one or more determined locations of a personal computing device of associated with the user may be identified. A determination may be made, by the system, as to whether the user was associated with multiple locations (of the locations determined or identified based on the presence of the personal computing device of the user) within a predetermined time period. This information may then be used to determine whether a potential issue exists (e.g., the user or customer is in need of additional assistance, a potential unauthorized transaction or other activity is underway, or the like).

For instance, a financial institution may have one or more location beacons positioned in different branches or banking centers throughout an area. The system, as discussed above, may detect a location beacon at a first location (e.g., by a personal computing device of the user) and may detect a location beacon at a second location. If the first and second beacons are detected within a predetermined period of time, that may indicate an issue and additional steps may be taken.

For instance, if the location beacons are detected within the predetermined period of time, that may be an indication that the user is attempting to obtain customer service, conduct a transaction, or the like, but may be having difficulties. In some arrangements, the user may, for instance, be attempting to obtain customer service and may not have received the desired assistance at the first beacon location (e.g., first branch or banking center) and so they attempted to obtain the desired service at the second beacon location (e.g., a second branch or banking center). The financial institution is interested in providing outstanding customer service and, accordingly, want to ensure that users have their issues addressed promptly and don't have to visit additional locations in order to obtain service. Accordingly, the system may notify the financial institution of the user's location at multiple branches in the predetermined period of time so that the financial institution may contact the user to ensure they have received the desired service, request suggestions for improving service, or the like.

Additionally or alternatively, detecting multiple location beacons within the predetermined amount of time may be an indication of a potential unauthorized activity or transaction. For instance, a personal computing device detecting multiple location beacons within the predetermined amount of time may indicate that a user (or person in possession of the device) may be engaged in suspicious activity. For instance, the person in possession of the device may be evaluating security in the locations, assessing the number of customers at a particular time of day, or the like, in order to plan or undertake an unauthorized activity. Accordingly, the system may notify the financial institution of the detection of the location beacons within the predetermined amount of time so that the financial institution may take action. For instance, the financial institution may increase security, transmit an alert identifying the user and instruct banking associates to request photo identification for transactions associated with that user, or the like.

Further, the in the arrangement discussed above, the system may notify the user of the detection of location beacons at multiple locations in order to confirm that the user is in possession of the personal computing device. For instance, the personal computing device may have been stolen and the user might not have been in possession of the device when the locating beacons were detected. Accordingly, the system may request confirmation from the user (e.g., via personal identification number (PIN), biometric data, response to a preset security question, or the like) that he or she is in possession of the device.

Although several examples provided herein are discussed in the context of a financial institution, the system may be used with various entities. For instance, a retailer may have location beacons arranged at different retail locations. Accordingly, if a personal computing device detects multiple beacons within a predetermined time period, that may indicate that the user is planning a theft or other unauthorized activity. Accordingly, the retailer may be notified of the issue and/or the user may be notified in order to confirm that the user is in possession of the device.

Although several examples discussed herein including detecting two locating beacons, three, four, or more locating beacons may be detected and used in the various determinations discussed herein without departing from the invention.

Further, the arrangements discussed herein may include detection of a signal by a personal computing device and transmitting the signal, or data associated therewith, to another portion of the system or another device, to determine the location of the beacon and/or device, as well as the identity of the user associated with the device. However, in some arrangements, the personal computing device may be configured to determine the location of the beacon, and thus, the location of the personal computing device, based on the received signal (e.g. by matching a signal that may be unique to the beacon with a stored list of beacons and associated locations). Some or all aspects of this arrangement may be performed by one or more applications associated with the personal computing device, such as an online or mobile banking application. The application may then determine the identity of the user (e.g., with or without accessing other devices) and may transmit user information to another device or component of the system to provide the additional functionality, as discussed herein.

The various arrangements discussed herein aid in improving customer service experiences for a user, as well as providing additional security to an entity and/or a user or customer.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
receiving, by a location determination and user identification system having at least one processor, data associated with a first signal detected by a personal computing device, the first signal being emitted from a first location beacon at a first banking center of a financial institution;
determining, by the location determination and user identification system, a first location of the personal computing device based on the received data associated with the first signal emitted from the first location beacon, wherein the first location of the personal computing device is within a predefined proximity of a location of the first location beacon;
extracting, by the location determination and user identification system, a unique identifier associated with the personal computing device;
determining, by the location determination and user identification system and based on the extracted unique identifier associated with the personal computing device, an identity of a user associated with the personal computing device;
receiving, by the location determination and user identification system, data associated with a second signal detected by the personal computing device, the second signal being emitted from a second location beacon located remotely from the first location beacon at a second banking center of the financial institution;
determining, by the location determination and user identification system, a second location of the personal computing device based on the received data associated with the second signal emitted from the second location beacon, wherein the second location of the personal computing device is within a predefined proximity of a location of the second location beacon;
determining, by the location determination and user identification system, whether the data associated with the second signal detected by the personal computing device was received within a predetermined threshold amount of time of receiving the data associated with the first signal detected by the personal computing device; and
responsive to determining that the data associated with the second signal detected by the personal computing device was received within the predetermined threshold amount of time of receiving the data associated with the first signal detected by the personal computing device, flagging at least one of: the personal computing device and identified user associated with the personal computing device.

2. The method of claim 1, further including:
determining whether at least one of: a duration of detection of the first signal and a duration of detection of the second signal are above a predetermined threshold duration; and
responsive to determining that the at least one of: a duration of detection of the first signal and a duration of detection of the second signal are above the predetermined threshold duration, generating a notification to contact the identified user regarding a customer service experience.

3. The method of claim 1, further including:
determining whether at least one of: a duration of detection of the first signal and a duration of detection of the second signal are above a predetermined threshold duration; and
responsive to determining that the at least one of: a duration of detection of the first signal and a duration of detection of the second signal are at or below the predetermined threshold duration, generating a notification providing an alert of a potential unauthorized activity.

4. The method of claim 1, wherein flagging the at least one of: the personal computing device and the identified user associated with the personal computing device further includes generating a notification to at least one of: the identified user associated with the personal computing device and the financial institution.

5. The method of claim 1, wherein flagging the at least one of: the personal computing device and the identified user associated with the personal computing device further includes generating a notification requesting the identified user associated with the personal computing device provide user input confirming the user's position at the first location of the personal computing device and the second location of the personal computing device; and transmitting the notification to the personal computing device.

6. The method of claim 5, further including:
receiving user input confirming the position of the user at the first location of the personal computing device and the second location of the personal computing device; and
responsive to receiving the user input confirming the position of the user, requesting user input associated with a customer service experience of the user when at at least one of: the first location and the second location.

7. The method of claim 5, wherein generating the notification further includes providing a list of recent transactions for review by the user.

8. The method of claim 1, further including:
receiving, by the location determination and user identification system, data associated with a third signal detected by the personal computing device, the third signal being emitted from a third location beacon located remotely from the first location beacon and the second location beacon and at a third banking center of the financial institution;
determining, by the location determination and user identification system, a third location of the personal computing device based on the received data associated with the third signal emitted from the third location beacon, wherein the third location of the personal computing device is within a predefined proximity of a location of the third location beacon;
determining, by the location determination and user identification system, whether the data associated with the third signal detected by the personal computing device was received within a predetermined threshold amount of time of receiving the data associated with the first signal detected by the personal computing device and the data associated with the second signal detected by the personal computing device; and
responsive to determining that the data associated with the third signal detected by the personal computing device was received within the predetermined threshold amount of time of the data associated with the second signal detected by the personal computing device and the data associated with the first signal detected by the personal computing device, flagging at least one of: the personal computing device and the identified user associated with the personal computing device.

9. An apparatus, comprising:
at least one processor; and
a memory storing instructions that when executed by the at least one processor cause the apparatus to:
receive data associated with a first signal detected by a personal computing device, the first signal being emitted from a first location beacon at a first banking center of a financial institution;
determine a first location of the personal computing device based on the received data associated with the first signal emitted from the first location beacon, wherein the first location of the personal computing device is within a predefined proximity of a location of the first location beacon;
extract a unique identifier associated with the personal computing device;
determine, based on the extracted unique identifier associated with the personal computing device, an identity of a user associated with the personal computing device;
receive data associated with a second signal detected by the personal computing device, the second signal being emitted from a second location beacon located remotely from the first location beacon and at a second banking center of the financial institution different from the first banking center;
determine a second location of the personal computing device based on the received data associated with the second signal emitted from the second location beacon, wherein the second location of the personal computing device is within a predefined proximity of a location of the second location beacon;
determine whether the data associated with the second signal detected by the personal computing device was received within a predetermined threshold amount of time of receiving the data associated with the first signal detected by the personal computing device; and
responsive to determining that the data associated with the second signal detected by the personal computing device was received within the predetermined threshold amount of time of receiving the data associated with the first signal detected by the personal computing device, flag at least one of: the personal computing device and the identified user associated with the personal computing device.

10. The apparatus of claim 9, further including instructions that, when executed, cause the apparatus to:
determine whether at least one of: a duration of detection of the first signal and a duration of detection of the second signal are above a predetermined threshold duration;
responsive to determining that the at least one of: a duration of detection of the first signal and a duration of detection of the second signal are above the predetermined threshold duration, generate a notification to contact the identified user; and
responsive to determining that the at least one of: a duration of detection of the first signal and a duration of detection of the second signal are at or below the predetermined threshold duration, generate a notification providing an alert of a potential unauthorized activity.

11. The apparatus of claim 9, wherein flagging the at least one of: the personal computing device and the identified user associated with the personal computing device further includes generating a notification to at least one of: the identified user associated with the personal computing device and the financial institution.

12. The apparatus of claim 9, wherein flagging the at least one of: the personal computing device and the identified user associated with the personal computing device further includes generating a notification requesting the identified user associated with the personal computing device provide user input confirming the users' position at the first location of the personal computing device and the second location of the personal computing device; and transmitting the notification to the personal computing device.

13. The apparatus of claim 12, further including instructions that, when executed, cause the apparatus to:
receive user input confirming the position of the user at the first location of the personal computing device and the second location of the personal computing device; and
responsive to receiving the user input confirming the position of the user, request user input associated with a customer service experience of the user when at at least one of: the first location and the second location.

14. The apparatus of claim 12, wherein generating the notification further includes providing a list of recent transactions for review by the user.

15. The apparatus of claim 9, further including instructions that, when executed, cause the apparatus to:
receive data associated with a third signal detected by the personal computing device, the third signal being emitted from a third location beacon located remotely from the first location beacon and the second location beacon, and at a third banking center of the financial institution;
determine a third location of the personal computing device based on the received data associated with the third signal emitted from the third location beacon, wherein the third location of the personal computing device is within a predefined proximity of a location of the third location beacon;
determine whether the data associated with the third signal detected by the personal computing device was received within a predetermined threshold amount of time of receiving the data associated with the first signal detected by the personal computing device and the data associated with the second signal detected by the personal computing device; and
responsive to determining that the data associated with the third signal detected by the personal computing device was received within the predetermined threshold amount of time of the data associated with the second signal detected by the personal computing device and the data associated with the first signal detected by the personal computing device, flag at least one of: the personal computing device and the identified user associated with the personal computing device.

16. One or more non-transitory computer-readable media having instructions stored thereon that when executed by one or more computers cause the one or more computers to:
receive data associated with a first signal detected by a personal computing device, the first signal being emitted from a first location beacon at a first banking center of a financial institution;
determine a first location of the personal computing device based on the received data associated with the first signal emitted from the first location beacon, wherein the first location of the personal computing device is within a predefined proximity of a location of the first locating beacon;
extract a unique identifier associated with the personal computing device;
determine, based on the extracted unique identifier associated with the personal computing device, an identity of a user associated with the personal computing device;
receive data associated with a second signal detected by the personal computing device, the second signal being emitted from a second location beacon located remotely from the first location beacon and at a second banking center of the financial institution different from the first banking center;
determine a second location of the personal computing device based on the received data associated with the second signal emitted from the second location beacon, wherein the second location of the personal computing device is within a predefined proximity of a location of the second location beacon;
determine whether the data associated with the second signal detected by the personal computing device was received within a predetermined threshold amount of time of receiving the data associated with the first signal detected by the personal computing device; and
responsive to determining that the data associated with the second signal detected by the personal computing device was received within the predetermined threshold amount of time of receiving the data associated with the first signal detected by the personal computing device, flag at least one of: the personal computing device and the identified user associated with the personal computing device.

17. The one or more non-transitory computer-readable media of claim 16, further including instructions that, when executed, cause the one or more computers to:
determine whether at least one of: a duration of detection of the first signal and a duration of detection of the second signal are above a predetermined threshold duration;
responsive to determining that the at least one of: a duration of detection of the first signal and a duration of detection of the second signal are above the predetermined threshold duration, generate a notification to contact the identified user regarding a customer service experience; and
responsive to determining that the at least one of: a duration of detection of the first signal and a duration of detection of the second signal are at or below the predetermined threshold duration, generate a notification providing an alert of a potential unauthorized activity.

18. The one or more non-transitory computer-readable media of claim 16, wherein flagging the at least one of: the personal computing device and the identified user associated with the personal computing device further includes generating a notification to at least one of: the identified user associated with the personal computing device and the financial institution.

19. The one or more non-transitory computer-readable media of claim 16, wherein flagging the at least one of: the personal computing device and the identified user associated with the personal computing device further includes generating a notification requesting the identified user provide user input confirming their position at the first location of the personal computing device and the second location of the personal computing device; and transmitting the notification to the personal computing device.

20. The one or more non-transitory computer-readable media of claim 16, further including instructions that, when executed, cause the one or more computers to:
receive data associated with a third signal detected by the personal computing device, the third signal being emitted from a third location beacon located remotely from the first location beacon and the second location beacon, and at a third banking center of the financial institution;
determine a third location of the personal computing device based on the received data associated with the third signal emitted from the third location beacon, wherein the third location of the personal computing device is within a predefined proximity of a location of the third location beacon;
determine whether the data associated with the third signal detected by the personal computing device was received within a predetermined threshold amount of time of receiving the data associated with the first signal detected by the personal computing device and the data associated with the second signal detected by the personal computing device; and
responsive to determining that the data associated with the third signal detected by the personal computing device was received within the predetermined threshold amount of time of the data associated with the second signal detected by the personal computing device and the data associated with the first signal detected by the personal computing device, flag at least one of: the personal computing device and the identified user associated with the personal computing device.
